(19) United States
(12) Patent Application Publication
(10) Pub. No.: US 2014/0280532 A1
(43) Pub. Date: Sep. 18, 2014

(54) SYSTEMS AND METHODS FOR DIGITALLY AUGMENTED NETWORKING

(71) Applicant: Sean MacNiven, Manheim (DE)

(72) Inventor: Sean MacNiven, Manheim (DE)

(73) Assignee: SAP AG, Walldorf (DE)

(21) Appl. No.: 13/801,396

(22) Filed: Mar. 13, 2013

(51) Int. Cl. H04L 29/08

(52) U.S. Cl. CPC H04L 67/306
USPC 709/204

(57) ABSTRACT

Various embodiments include at least one of systems, methods, and software for digitally augmented networking. Some such embodiments include a server that performs various data processing operations related therefor. In some embodiments, the server operates to receive, via a network, data identifying a first user and a location of the first user. The server may then identifying other users within a proximity of the location of the first user and compare a profile of the first user with profiles of the identified other users to identify profile matches between the first user and identified other users. Next the server may generate and send introduction communications to each of the first user and at least one of the matched other users to introduce the first user and the at least one matched other user. Some embodiments further include client applications, web browser-based, and mobile device apps that operate in concert herewith.

### BACKGROUND INFORMATION

People often attend events, such as conferences, with the intent of networking with others with whom they may be able to do business or otherwise collaborate. However, as event size grows, so do the number of people in attendance. This makes meeting the desired people or types of people more challenging. While there may be more people to meet, finding the right people becomes more challenging. Further, even when an attendee knows an identity of someone they would like to meet, locating that person at an event can be challenging.

### BRIEF DESCRIPTION OF THE DRAWINGS

FIG. 1 is a logical block diagram of a system, according to an example embodiment.

FIG. 2 is a set of user interface illustrations, according to an example embodiment.

FIG. 3 is a user interface illustration, according to an example embodiment.

FIG. 4 is a block flow diagram of a server method, according to an example embodiment.

FIG. 5 is a block flow diagram of a client computing device method, according to an example embodiment.

FIG. 6 is a block diagram of a computing device, according to an example embodiment.

### DETAILED DESCRIPTION

Various embodiments herein include at least one of systems, methods, and software for digitally augmented networking. Such embodiments generally include a server system that stores or accesses profile data of event attendees to propose, to an event attendee, introductions to other event attendees. An attendee may utilize a mobile device app or a web browser-based application to communicate with the server system to request introduction proposals. Such a request may include one or more of a profile identifier, select profile information, requesting attendee location information, an identifier of an introduction selection method specifying how other attendees are to be selected for the introduction proposals, and other data. In some embodiments, the server system, upon receipt of such an introduction request, identifies other event attendees in accordance with the request and provides introduction proposals for other event attendees to the requesting user. The requesting user can then review the proposed introductions and select one or more other attendees proposed. Upon selection, a request to meet will then be transmitted to the server system and relayed to the one or more selected event attendees.

The one or more selected event attendees may then receive a meeting request on a mobile device app, within a web browser-based application, SMS text message, text-based chat message, or other communication mechanism. Each of the one or more selected event attendees, upon receipt of the meeting request, may then decline or accept the meeting request. The decline or acceptance will then be communicated, via the server system, to the requestor. When a meeting request is accepted, additional data may be exchanged via the server system, which may include facilitation of a telephone call, SMS text messaging between the attendees that are to meet, and the like. This additional data is exchanged to facilitate direct communication between the attendees, which may include an in person meeting or further direct voice or data communication via a network.

These and other embodiments are illustrated and described herein with reference to the figures.

In the following detailed description, reference is made to the accompanying drawings that form a part hereof, and in which is shown by way of illustration specific embodiments in which the inventive subject matter may be practiced. These embodiments are described in sufficient detail to enable those skilled in the art to practice them, and it is to be understood that other embodiments may be utilized and that structural, logical, and electrical changes may be made without departing from the scope of the inventive subject matter. Such embodiments of the inventive subject matter may be referred to, individually and/or collectively, herein by the term “invention” merely for convenience and without intending to voluntarily limit the scope of this application to any single invention or inventive concept if more than one is in fact disclosed.

The following description is, therefore, not to be taken in a limited sense, and the scope of the inventive subject matter is defined by the appended claims.

The functions or algorithms described herein are implemented in hardware, software or a combination of software and hardware in one embodiment. The software comprises computer executable instructions stored on computer readable media such as memory or other type of storage devices. Further, described functions may correspond to modules, which may be software, hardware, firmware, or any combination thereof. Multiple functions are performed in one or more modules as desired, and the embodiments described are merely examples. The software is executed on a digital signal processor, ASIC, microprocessor, or other type of processor operating on a system, such as a personal computer, server, a router, or other device capable of processing data including network interconnection devices.

Some embodiments implement the functions in two or more specific interconnected hardware modules or devices with related control and data signals communicated between and through the modules, or as portions of an application-specific integrated circuit. Thus, the exemplary process flow is applicable to software, firmware, and hardware implementations.

FIG. 1 is a logical block diagram of a system 100, according to an example embodiment. The system 100 is an example of a computing environment within which some embodiments of digitally augmented networking are implemented. The system 100 includes a digital networking augmentation server 102 connected to a network 108. Also typically connected to the network 108 are computing devices 110. In some embodiments, additional systems and components may also be connected to the network 108 and involved in digital augmented networking. For example, one or more third-party user profile databases 120 may be connected to the network 108 and the data stored therein utilized for digitally augmented networking. Further, one or more fixed location Radio Frequency Identification (RFID) readers 130 may be included in some embodiments. In other embodiments, rather than RFID readers 130, alternative hardware may be included that forms a part of an Indoor Positioning System.

The digital networking augmentation server 102 operates to communicate with and provide digital networking augmentation services to users. The digital networking augmentation server 102 is typically deployed to and executes on one or more computing devices. In some embodiments, processes of the digital networking augmentation server 102 are executed on one or more computing devices and data received and processed thereby is stored on one or more other computing devices, such as may include a database management system.

Users may access services of the digital networking augmentation server over the network 108 in different ways. For example, various embodiments include computing device 110 apps and applications, web browser-based applications, kiosk applications, set-top box apps, apps executable within an automobile information system, and other apps and applications accessible on various computing devices. Each of such embodiments through which digital networking augmentation services are provided to users include user interfaces through which users are able to view data from and provide input to the digital networking augmentation server.

In some embodiments, the digital networking augmentation server 102 includes two general modules—a profile module 104 and an introduction module 106. However, the functionality and services of the digital networking augmentation server 102 may be arranged, organized, and provided in a single module or more than two modules.

The profile module 104 generally operates to provide user profile related services. For example, users may register as attending an event by accessing a registration service of the profile module. In some such embodiments, users are provided with abilities to link a profile stored by the profile module 104 with one or more other profiles, such as the user may possess or maintain within other systems. Such other systems may include third-party user profile databases 120 as discussed further below. The profile module 104 in such embodiments may include further services to access, create, and update data within one or more of the third-party user profile databases 120, such as to provide status updates, location updates, create relationship connections, and the like. The profile module 104 also typically provides one or more profile matching services.

A profile matching service of the profile module 104 is a service that is executable to receive a profile matching request to identify one or more other users having profiles stored or otherwise represented in data accessible to the profile module 104. For example, a digital networking augmentation user may desire to meet other attendees at an event. The user may generate a profile matching request through manipulation of a user interface of a computing device 110 app. The manipulation of the user interface will generally provide parameters of the profile matching request, such as one or more of a mode of profile matching to be performed, profile characteristics to consider in the matching, a location of the requesting user, and the like.

In some embodiments, a profile matching request is received by the profile module 104 over the network 108 from the requesting user's computing device 110 or from another service of the digital networking augmentation server 102, such as from the introduction module 106. The profile matching module 104 then processes the received request to identify one or more other user profiles matching parameters of the received request. Profile data considered by the profile matching module 104 may include user profile data stored by the digital networking augmentation server 102, data stored within third-party user profile databases 120, and other public and private data sources. The output of the profile matching service, in some embodiments, may include one of more profile identifiers of each matched profile. However, in other embodiments, further data may be provided, such as one or more of profile identifiers, names, location data, images, and other profile data. The output will typically be provided to the caller of the profile matching service, whether that be the introduction module 106 or a an

As described above, data stored in third-party user profile databases 120 may be utilized in some embodiments. The third-party user profile databases 120 may generally include data stored by other data processing systems. Such other data processing systems may include one or more of Customer Relationship Management (CRM), Enterprise Resource Planning (ERP), and other business-type computing systems. Such data processing systems, when implemented by a larger enterprise, are referred to as enterprise-class management computer applications or systems. In some further embodiments, such other data processing systems may include social media platforms, services, and websites that provide various social media related web services. Such social media platforms, services, and websites generally store data in registered user profiles, data with regard to relationships, interests, hobbies, educational institutions attended, familial relations, employment and volunteer positions held, and the like. Data stored by such other data processing systems, referred to herein as third-party user profile databases 120, is leveraged in some embodiments in determining digital augmented networking users to introduce to one another, such as through calls made to a profile matching service of the profile module 104.

Data stored by the third-party user profile databases 120 may be accessed through calls to functions and services provided by systems of respective third parties. For example, it is common for social media websites and platforms to provide web services and programming environments that allow for access to their stored user data. Further, many applications and systems include services, or can be augmented with custom services, to provide access to stored data. Thus, various embodiments may leverage existing third-party services or programming environments through deployed custom code elements.

Referring back to the digital networking augmentation server 102, some embodiments include an introduction module 106. The introduction module 102, in some such embodiments, provides services to web browser-based applications, stand-alone applications, and mobile computing device 110 apps for digital networking augmentation. Such services may provide data to populate user interfaces, user interface definition data, and other data for presentation to a user. Such services may also include data processing services to receive input submitted by a user through a user interface requesting profile matched users and provide a response thereto, requesting to meet one or more profile matched users, receive requests for and provide user profile data, provide map views of profile matched users and a current user location, and other services.

In some embodiments, a user may access a digital network augmentation application, such as through a mobile computing device 110 app or a web browser-based application. The user will typically enter data into a user interface requesting a view of profile matched users. The data entry may simply be a selection of an action button presented within a user interface. However, in some embodiments, the user may specify parameter for profile matching.

For example, a user may specify a mode of profile matching to be performed. Such modes may include an opposite mode where users are matched where there are few similarities between a profile of the request user, as stored or otherwise accessed by the digital network augmentation server 102, and other user profiles, as stored or otherwise accessed by the digital network augmentation server 102. Another mode may include a similar matching mode where user profiles are matched based on similarities. Yet a further mode, requiring very little user input, is a random mode where user profiles are matched according to very few comparisons of data, such only location or event data indicating the requesting user is in close proximity or at the same event as one or more matched users. One other mode may be a matching based on current customers of the user or an organization for which the user works or otherwise represents. Such matching may be based in part on profile or company data accessed from one or more of the third-party databases 120, such as a third-party database 120 storing data of an enterprise-class management computer application (i.e., and ERP or CRM application). Further and different matching modes may be included is different embodiments.

User specified matching parameters for profile matching may further include other data. For example, some other data for profile matching may include data representative of profile characteristics, such as a current employment position held, gender, industry working in, place of residence, current physical location, educational institutions attended, place of employment, hobbies, interests, and other profile characteristic related data.

Once a user has provided input into a user interface through which a view of profile matched users can be requested, a request can be generated and transmitted via the network to the introduction module 106. The introduction modules may then submit a request based thereon to the profile module 104, as discussed above, to obtain profile matched user data. The profile matched user data is then utilized by the introduction module 106 to generate a reply to the requesting user. The reply may include a map image of an event location or a geographical area within which the requesting user is located. The map image generated may then be plotted to include identifiers of locations where the profile matched users are located. When transmitted to the requesting user, the map may be presented and a graphical representation of the location identifiers of the profile matched users may be selected to view additional information, such as profile information, of each profile matched user. In other embodiments, the reply may simply be a listing of profile matched user, which may be augmented with limited profile data of each profile matched user. In such embodiments, when the listing is transmitted and presented to the requesting user, the data of the profile matched users may be selected to view further profile data. Other representations of profile matched users may also be provided in the reply from the introduction module 106 to the requesting user, such as graphs indicating matching relevance of each profile matched user, images of each profile matched user, among other possible representations.

Regardless of the representation type provided to the requesting user, the mobile computing device 110 app or web browser-based application utilized by the user presents a view of the representation. The user may then select a user interface control to request an introduction to one or more particular other users represented in the view. Such a selection, in some embodiments, causes an introduction request to be transmitted over the network 108 to the introduction module 106. The introduction module 106, upon receipt of the introduction request, transmits a form of the introduction request to each of one or more particular other uses identified in the introduction request. The introduction request may be sent to each of the other users via an in-app message of a mobile computing device 110 app of each of the other users. In other embodiments, the introduction request may be presented within a web browser-based app of each of the other users. In yet further embodiments, the introduction request may be sent via SMS text message, a text-based chat message, a voice message via an automated telephone call, among other possibilities depending on the particular embodiment. However, in some embodiments, rather than the introduction request from the requesting user being sent to the introduction module 106 and relayed, the introduction request is instead sent directly to each of the one or more other users. When sent directly to each of the other users, the introduction request can be sent in the form of a peer-to-peer communication to an app on a mobile computing device 110 of each of the one or more other users. Peer-to-peer connectivity data in such embodiments may be included in user profile data received from the introduction module 106 and as may be stored in a user profile data.

The introduction request, when received by one of the one or more users for which the requesting user would like to meet, will be presented to the receiving user. The introduction request may be presented on a computing device 110 of the receiving user, such as within a digital networking augmentation mobile computing device 110 app of the user, in an SMS text message, within a web browser-based application, or otherwise. In some embodiments, when the request is received in an SMS text message, the message may include a hyperlink to access a webpage to view and respond to the request. When the request is received within a digital networking augmentation mobile computing device 110 app of the user or within a web browser-based application, the user may choose to accept or reject the request. The request when presented to the receiving user may be presented with options to view a map showing a current location of the requesting user, a profile of the requesting user, a picture of the requesting user, and other details with regard to the requesting user, depending on the particular embodiment. Another option may be presented to the receiving user to accept the request and to schedule a time and location for a meeting.

When the receiving user accepts or rejects the introduction request, a data indication thereof, including any further data depending on the embodiment (i.e., a suggested time and location for a meeting) may be transmitted to the introduction module 106 and relayed to the requesting user. In a peer-to-peer embodiment, the same may instead be transmitted directly to a mobile computing device 110 app of the requesting user.

As generally discussed already, some embodiments may utilize location-based services in various forms, such as identifying users by location, providing maps of user locations, and the like. Some such embodiments may utilize location-based services provided on mobile computing devices 110 of users. Such location-based services may include Global Positioning System (GPS) sensors of mobile computing devices 110. In other embodiments, the user locations may be determined based on known positions of Wi-Fi routers or mobile communication towers to which user devices are connected. Yet other embodiments may utilize fixed-location RFID readers 130 deployed at an event. In such RFID embodiments, users may be issued an item, such as a name badge, to which an RFID tag is affixed and an identifier of which is registered with a profile of the respective user. Thus, as a user moves about an event, the RFID tag can be scanned and the location recorded with the digital networking and augmentation server 102. Regardless of how user location is determined, the location is recorded with the digital networking and augmentation server 102 and stored in association with the respective user's profile data.

With regard to the fixed-location RFID readers 130, the fixed-location RFID readers 130 may be standalone, networked RFID readers programmed to transmit data identifying the RFID reader and read RFID tag identifiers to a service of the digital networking augmentation server 102. The digital networking augmentation server 102 may also store data representative of a location of each fixed-location RFID reader 130. In other embodiments, an RFID reader may be coupled to a computing device 110 at a fixed location. The computing device 110 in such embodiments may then similarly report read RFID tag identifiers to the digital networking augmentation server 102 for user location recording. In a further embodiment, an RFID reader may instead be mobile, such as an RFID reader coupled to a mobile computing device 110. A mobile computing device having a coupled RFID reader may be location aware, such as according to one or more mechanisms or methods as described above. In such embodiments, a mobile computing device having a coupled RFID reader similarly reports identifiers of read RFID tags and location identifying data to the digital networking augmentation server 102.

In some other embodiments, rather than fixed-location RFID readers 130, other components and methodologies for identifying and tracking locations of individuals may be used. Some such embodiments may include an Indoor Positioning System (IPS). An IPS generally includes a set of networked devices used to locate objects and people inside a building, such as a building where a conference is being held, a place of employment, and other buildings. An IPS includes known position anchors that actively locate active or passive transponders, such as active or passive RFID tags or other similar types of transponders. Based on responses to interrogating signals received by one or more IPS sensors from a tagged person or object, software of an IPS determines a location of the tag and therefore the associated individual or object. Further, some IPS embodiments include tracking abilities that determine, based on multiple detected locations of a tagged person or object, a trajectory. In such embodiments, further introduction recommendations may be made based on trajectories of individuals that are due to intersect, are intersecting, or are otherwise in close proximity.

Thus, according to these various embodiments described with regard to the system 100 of FIG. 1, the digital networking augmentation server 102 provides user introduction and profile viewing capabilities to users. In some such embodiments, the digital networking augmentation server 102 may provide a standalone service. However, in other embodiments, the digital networking augmentation server 102 may be incorporated within a computing infrastructure of another application or system, such as a social media website or platform, an ERP or CRM system, a store management system, a system utilized by public safety personnel at events or incidents, and other system types. Thus, although the present embodiments have primarily been described with regard to providing social networking related services at events, such as conferences, other embodiments may be implemented for other purposes in concert with other system platforms.

FIG. 2 is a set of user interface illustrations 202, 204, 206, according to an example embodiment. The user interfaces 202, 204, 206 of FIG. 2 are examples of user interfaces of some embodiments that may be presented within a mobile computing device app, such as an app that is stored and executed on a smartphone. The user interfaces 202 and 204 are examples of user interfaces that may be presented to a user to request introductions. The user interface 206 is an example of a user interface presented to a user with whom a requesting user has requested a meeting.

The user interface 202 includes a map showing a current location of the user. The user interface 202 further includes profile matching options, each of which can be selected to request introduction proposals. When an introduction proposal option is selected, an introduction proposal request is sent and a response is received with data representative of one or more other users for whom introductions are proposed. The received data may include a map and location data with regard to each of the one or more other users. Such a map is illustrated within the user interface 204 with locations of the one or more other users plotted thereon.

Within the user interface 204, a user may select an icon of a user for whom an introduction is proposed. Selection of an icon may present different options to the viewing user. The viewing user may select options to view profile data of the respective other user, view message posted by the respective other user to a social media platform or website, and view other respective other user data. Additionally, an option may be selected by the viewing user requesting an introduction. When a selection of an introduction request is selected, a meeting proposal is sent to the respective other user.

The meeting proposal, when received by an app of the respective other, is presented. The user interface 206 is an example of how the meeting proposal may be presented. When presented, the user interface 206 may present options to the receiving user to view profile data with regard to the requesting user. The user interface 206 further presents options to accept or decline the proposed meeting. When accepted or declined, an according message is transmitted back to the requesting user.

FIG. 3 is a user interface 302 illustration, according to an example embodiment. The user interface 302 is an example of a user interface that may be presented to both of the requesting user and receiving user following the receiving user accepting a meeting proposal, such as through the user interface 206 of FIG. 2. The user interface 302 included a map through which location input can be received and communicated between users to set a location for a meeting.

FIG. 4 is a block flow diagram of a server method 400, according to an example embodiment. The method 400 is an example of a method that may be performed by a digital networking augmentation server 102 of FIG. 1. The method 400 includes receiving 402, via a network on a computing device performing the method 400, data identifying a first user and a location of the first user. The method 400 may then identify 404 other users within proximity of the location of the first user, such as by comparing the location of the first user with stored location data of the other users. The method 400 further compares 406 a profile of the first user with profiles of the identified other users to identify profile matches between the first user and identified other users. Communications may then be generated and sent to each of the first user and at least one of the matched other users to introduce the first user and the at least one matched other user.

In some embodiments, the method 400 may further include determining an event the first user is attending, such as a conference, a concert, incident, or other event. In one such embodiment, identifying other users within proximity of the location of the first user consists essentially of limiting a universe of the other users within proximity of the location of the first user to other users attending the same event as the first user. In yet further embodiments, the proximity is a distance, a floor number, a zip code, a state, or other delimited geographic region.

In another embodiment of the method 400, generating and sending 408 introduction communications to the first user and the at least one matched other user includes generating a dataset renderable on a mobile device of the first user and on a mobile device of the at least one matched other user. Such a dataset may include data identifying the respective user to which an introduction is being provided. The identifying data may include one or more of a name, phone number, picture, a link to a web page profile of the user, and other such data.

FIG. 5 is a block flow diagram of a client computing device method 500, according to an example embodiment. The method 500 is an example of a method that may be performed by a mobile computing device client app. In some embodiments, the method 500 includes receiving 502 first input from a first user requesting an introduction to another user and generating and submitting 504, via a network to an introduction module, a request based on the first input and data representative of a location of the first user. In response thereto, the method 500 includes receiving and presenting 506 a view of data identifying a second user. A second input confirming the first user desires an introduction to the second user may then be received 508. Upon receipt 508 of the second input, the method 500 generates and submits 510 a confirmation based on the second input to the introduction module. The method 500 may then receive 512 data confirming the second user accepted the introduction request and location identifying data of the second user.

FIG. 6 is a block diagram of a computing device, according to an example embodiment. In one embodiment, multiple such computer systems are utilized in a distributed network to implement multiple components in a transaction-based environment. An object-oriented, service-oriented, or other architecture may be used to implement such functions and communicate between the multiple systems and components. One example computing device in the form of a computer 610, may include a processing unit 602, memory 604, removable storage 612, and non-removable storage 614. Although the example computing device is illustrated and described as computer 610, the computing device may be in different forms in different embodiments. For example, the computing device may instead be a smartphone, a tablet, or other computing device including the same or similar elements as illustrated and described with regard to FIG. 6. Further, although the various data storage elements are illustrated as part of the computer 610, the storage may also or alternatively include cloud-based storage accessible via a network, such as the Internet.

Returning to the computer 610, memory 604 may include volatile memory 606 and non-volatile memory 608. Computer 610 may include—or have access to a computing environment that includes a variety of computer-readable media, such as volatile memory 606 and non-volatile memory 608, removable storage 612 and non-removable storage 614. Computer storage includes random access memory (RAM), read only memory (ROM), erasable programmable read-only memory (EPROM) & electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions. Computer 610 may include or have access to a computing environment that includes input 616, output 618, and a communication connection 620. The input 616 may include one or more of a touchscreen, touchpad, mouse, keyboard, camera, and other input devices. The computer may operate in a networked environment using a communication connection 620 to connect to one or more remote computers, such as database servers 634, web servers 636, and other computing device. An example remote computer may include a personal computer (PC), server, router, network PC, a peer device or other common network node, or the like. The communication connection 620 may be a network interface device such as one or both of an Ethernet card and a wireless card or circuit that may be connected to a network. The network may include one or more of a Local Area Network (LAN), a Wide Area Network (WAN), the Internet, and other networks.

Computer-readable instructions stored on a computer-readable medium are executable by the processing unit 602 of the computer 610. A hard drive (magnetic disk or solid state), CD-ROM, and RAM are some examples of articles including a non-transitory computer-readable medium. For example, various computer programs or apps, such as one or more applications and modules stored on and executed by a digital networking augmentation server 102 of FIG. 1 or a digital networking augmentation app or application executable on a mobile device or is accessible via a web browser, may be stored on a non-transitory computer-readable medium.

It will be readily understood to those skilled in the art that various other changes in the details, material, and arrangements of the parts and method stages which have been described and illustrated in order to explain the nature of the inventive subject matter may be made without departing from the principles and scope of the inventive subject matter as expressed in the subjoined claims.

What is claimed is:

1. A method comprising:
receiving, via a network on a computing device, data identifying a first user and a location of the first user;
identifying other users within proximity of the location of the first user;
comparing a profile of the first user with profiles of the identified other users to identify profile matches between the first user and identified other users;
generating and sending introduction communications to each of the first user and at least one of the matched other users to introduce the first user and the at least one matched other user.

2. The method of claim 1, further comprising:
determining an event the first user is attending; and
wherein identifying other users within proximity of the location of the first user consists essentially of limiting a universe of the other users within proximity of the location of the first user to other users attending the same event as the first user.

3. The method of claim 1, wherein generating and sending introduction communications to the first user and the at least one matched other user includes generating a dataset renderable on a mobile device of the first user and on a mobile device of the at least one matched other user, the dataset including data identifying the respective user to which an introduction is being provided.

4. The method of claim 1, wherein the comparing of the profile of the first user with profiles of the identified other users to identify profile matches is performed according to a matching method identified in a data communication received via the network from the first user.

5. The method of claim 1, wherein the first user and the other users each include a profile stored in at least one database against which the comparing of the profile of the first user with profiles of the identified other users is performed.

6. The method of claim 1, further comprising:
retrieving profile data of the first user and each of the identified other users from at least one third-party online profile repository; and
wherein the comparing is performed at least in part against the retrieved profile data.

7. The method of claim 1, wherein generating and sending introduction communications to each of the first user and at least one matched other user includes:
generating and sending a meeting request to the at least one matched other user;
receiving a communication including data indicating the at least one matched other user accepts the meeting request;
communicating the meeting request communication to the first user.

8. The method of claim 7, further comprising:
transmitting location information to each of the first user and the at least one matched other user identifying respective locations of the other.

9. A method comprising:
receiving first input from a first user requesting an introduction to another user;
generating and submitting, via a network to an introduction module, a request based on the first input and data representative of a location of the first user;
receiving, via the network, and presenting a view of data identifying a second user;
receiving second input confirming the first user desires an introduction to the second user;
generating and submitting, via the network to the introduction module, a confirmation based on the second input; and
receiving, via the network, data confirming the second user accepted the introduction request and location identifying data of the second user.

10. The method of claim 9, wherein the first input further includes input selecting a mode of matching the first user to other users by a matching process of the introduction module.

11. The method of claim 9, wherein receiving data confirming the second user accepted the introduction request further includes connectivity data to initiate a communication session between the first user and the second user via a device on which the method is being performed.

12. The method of claim 9, wherein the first input further includes data identifying an event the first user is attending to limit introductions provided by the introduction module to other users attending the event.

13. The method of claim 9, further comprising:
receiving, via the network from the introduction module, an introduction request from a third user, the introduction request including profile data of the third user;
presenting the profile data to the first user;
receiving third input accepting the introduction request;
transmitting, via the network to the introduction module, an acceptance of the introduction.

14. The method of claim 13, wherein the data identifying the second user is a user within proximity of the first user.

15. A system comprising:
at least one processor, at least one memory device, and at least one network interface;
a profile module stored on the at least one memory device and executable on the at least one processor to provide access to user profile data of at least one of the system and a third-party user profile database, the user profile data including location related data for at least some users, the profile module including a matching service to match a profile of a requesting user with profiles of other users;
an introduction module, stored on the at least one memory device and executable on the at least one processor to:
receive, via the at least one network interface device, data identifying a requesting user and a location of the requesting user;
requesting user identifying data of a profile-matched user from the profile module based on the data identifying the requesting user and the location of the requesting user;
receiving user identifying data of the profile-matched user from the profile module; and
generating and sending, via the at least one network interface device, introduction communications to each of the requesting user and the profile-matched user.

16. The system of claim 15, wherein the location related data of user profiles is data identifying an event for which a respective user is registered to attend, has attended, or is attending.

17. The system of claim 15, wherein the matching service of the profile module includes a plurality of profile matching methods.

18. The system of claim 17, wherein the introduction module is further executable by the at least one processor to:
receive, via the at least one network interface device from the requesting user, an identifier of at least one profile matching method to be applied in identifying the profile-matched user.

19. The system of claim 15, wherein the third-party user profile database includes a database of an enterprise-class management computer application.

20. The system of claim 15, wherein the data identifying the location of the requesting user includes latitude and longitude coordinates.
